(19) United States
(12) Patent Application Publication
(10) Pub. No.: US 2004/0115030 A1
(43) Pub. Date: Jun. 17, 2004

(54) Detachable connection arrangement

(75) Inventors: Helmut Schwarz, Weil der Stadt (DE); Bernhard Homner, Calw (DE)

Correspondence Address: GREENBLUM & BERNSTEIN, P.L.C., 1950 ROLAND CLARKE PLACE, RESTON, VA, 20191, US

(73) Assignee: Schwarz Verbindungs-Systeme GmbH, Althengstett (DE)

(21) Appl. No.: 10/718,593

(22) Filed: Nov. 24, 2003

(30) Foreign Application Priority Data
Nov. 26, 2002 (DE) 202 18 300.9

(51) Int. Cl. F16B 39/36

(52) U.S. Cl. 411/270

(57) ABSTRACT

Connection arrangement for detachably connecting a first component to a second component. The arrangement includes a retaining bolt adapted to extend through the first component. The retaining bolt includes an external thread. A connector device is adapted to receive the retaining bolt. The connector device includes at least two shell-shaped threaded-nut segments and a housing which includes an opening adapted to receive an end of the retaining bolt and an internal taper which tapers towards the opening. Each of the at least two shell-shaped threaded-nut segments are arranged in the housing and include an outer tapered surface which movably engages the inner tapered surface of the housing. A mechanism for biasing the at least two shell-shaped threaded-nut segments towards the opening of the housing is utilized. A vibration-damping member is provided. The connector device is mounted to the vibration damping member. The at least two shell-shaped threaded-nut segments are adapted to threadably engage the external threads of the rotatable retaining bolt. This Abstract is not intended to define the invention disclosed in the specification, nor intended to limit the scope of the invention in any way.

### CROSS-REFERENCE TO RELATED APPLICATIONS

The present application claims priority under 35 U.S.C. § 119 of German Patent Application No. 202 18 300.9, filed on Nov. 26, 2002, the disclosure of which is expressly incorporated by reference herein in its entirety.

### BACKGROUND OF THE INVENTION

1. Field of the Invention

The invention refers to a detachable locking/bolting connection arrangement for two components.

2. Discussion of Background Information

Numerous detachable connection arrangements exist which make use of different connection principles (e.g. plug-in, lock-in, threaded connections).

To mount components with large surface areas (e.g. interior-wall paneling) several connection arrangements per component are often necessary to achieve a secure hold.

Installing components of this kind, especially with several connection arrangements per component, requires considerable skill and patience, especially where the work is done by one person only. The person will have to hold the component in position with one hand while making the individual connections with the other. If the component should slip out of position accidentally, a new attempt has to be made.

### SUMMARY OF THE INVENTION

In order to avoid this disadvantage, the invention provides for a detachable arrangement which permits simple loose temporary fixing of the connection elements. For example, it should be possible to attach the component loosely by pressing it lightly onto the mounting frame in such a way that it can no longer drop off.

Thanks to this kind of loose connection, the installer can now use both hands to align the component and tighten the individual connection arrangements.

The invention also provides for a connection arrangement for detachably connecting two components having openings which are aligned with one another, wherein the arrangement includes a rotatable retaining bolt on the side of the first component which can be introduced into the openings. A bolt connector is attached to the second component. The rotatable retaining bolt has an exterior thread. The bolt connector has a housing with an interior taper tapering towards the opening for receiving the end of the rotatable retaining bolt. At least two shell-shaped threaded-nut segments are located in the housing. Each segment has an outer mantle with a bevel to fit the interior taper. The threaded-nut segments and their outer mantles can be moved on the interior taper towards or away from the housing opening. The threaded-nut segments are spring loaded towards the housing opening. The rotatable retaining bolt can be pressed in between the movable threaded-nut segments against the force of the spring in such a way that its thread locks into that of the threaded-nut segments and that the thread of the rotatable retaining bolt connects with the thread of the threaded-nut segments when the rotatable retaining bolt is rotated.

The threaded-nut segments may have a space between them and stops may be located on the interior wall of the housing which project into the spaces between the threaded-nut segments in order to limit the axial rotatability of the threaded-nut segments.

A spiral pressure spring may be located in the housing which presses the threaded-nut segments towards the opening in the housing.

The spiral spring may be located between the floor of the housing and a disk which can be moved in the direction of the axis of the rotatable retaining bolt and which lies against the threaded-nut segments.

The floor of the housing and the disk have an opening to guide the rotatable retaining bolt.

The housing may have an edge projecting outwards or edge-segments projecting outwards.

The outwardly projecting edge may be a flange for attaching a component.

The bolt connector may be located in a vibration-damping ring of a vibration-damping material, preferably rubber or elastomer.

The vibration-damping ring may be connected with the interior wall of an open hollow cylinder, which has a supporting edge pointing outwards or segments of a supporting edge pointing outwards.

The vibration-damping ring or the hollow cylinder can be located in the opening of the second component.

The second component may lie on the supporting edge or the segments of the supporting edge of the hollow cylinder or are connected to it (them).

A vibration-damping and/or anti-slip material may be located on the supporting edge or the segments of the supporting edge, or may be applied as a coating.

The edge or the edge segments may extend beyond the projection of the interior dimension of the hollow cylinder.

A centering ring with a beveled inner edge may be located above the opening of the housing.

A guide sleeve for the rotatable retaining bolt may be located in the opening of the first component. The guide sleeve may have a retaining edge lying against the first component, and resilient sleeve arms whose free ends have tappets which hook over the lower edge of the opening of the hole in the first component.

The invention also provides for a detachable connector for connecting with a threaded bolt wherein the connector includes a housing having an inner taper tapering towards the opening for receiving the end of the threaded bolt. At least two shell-shaped threaded-nut segments are located in the housing. Each segment has an outer mantle having a bevel to fit the inner taper. The threaded-nut segments and their outer mantles can be moved on the interior taper towards or away from the housing opening. The threaded-nut segments are spring loaded towards the housing opening. The threaded bolt can be pressed in between the threaded-nut segments against the force of the spring in such a way that its thread locks into that of the threaded-nut segments. The thread of the bolt is adapted to connect and/or threadably engage with the thread of the threaded-nut segments when the threaded bolt is rotated.

The threaded-nut segments may have a space between them and that stops are located on the interior wall of the housing which project into the spaces between the threaded-nut segments in order to limit the axial rotatability of the threaded-nut segments.

A spiral pressure spring may be located in the housing which presses the threaded-nut segments towards the opening in the housing. The spiral spring may be located between the floor of the housing and a disk which can be moved in the direction of the axis of the threaded bolt and which lies against the threaded-nut segments.

A floor of the housing and a disk may each have an opening to guide the threaded bolt.

The invention also provides for a connection arrangement for detachably connecting a first component to a second component, wherein the arrangement comprises a retaining bolt adapted to extend through the first component. The retaining bolt comprises an external thread. A connector device is adapted to receive the retaining bolt. The connector device comprises at least two shell-shaped threaded-nut segments and a housing which includes an opening adapted to receive an end of the retaining bolt and an internal taper which tapers towards the opening. Each of the at least two shell-shaped threaded-nut segments are arranged in the housing and comprising an outer tapered surface which movably engages the inner tapered surface of the housing. A mechanism is utilized for biasing the at least two shell-shaped threaded-nut segments towards the opening of the housing. The at least two shell-shaped threaded-nut segments are adapted to threadably engage the external threads of the retaining bolt.

The connecting arrangement may be adapted to detachably connect the first component having a first opening to the second component having a second opening when the first and second openings are aligned with one another. The outer tapered surface of each shell-shaped threaded-nut segment may have the form of a bevel. Each of the at least two shell-shaped threaded-nut segments may be adapted to move towards and away from the opening of the housing. The mechanism for biasing the at least two shell-shaped threaded-nut segments towards the opening of the housing may comprise a spring.

The retaining bolt may be adapted to move the at least two shell-shaped threaded-nut segments against the biasing force of the mechanism for biasing, the external threads of the retaining bolt are adapted to move, without rotating, past internal threads of the at least two shell-shaped threaded-nut segments, and the external threads of the retaining bolt are adapted to threadably engage with the internal threads of the at least two shell-shaped threaded-nut segments when the retaining bolt is rotated.

The at least two shell-shaped threaded-nut segments may be spaced apart from each other. The arrangement may further comprise stops arranged in the housing, wherein the at least two shell-shaped threaded-nut segments are spaced apart from each other via the stops. The stops may be located on an inner surface of the housing and project into spaces separating the at least two shell-shaped threaded-nut segments, whereby the stops prevent rotational movement of the at least two shell-shaped threaded-nut segments.

The mechanism for biasing may be located in the housing. The mechanism for biasing may be located between a floor of the housing and an annular member which is adapted to move axially. The annular member may comprise one of a disk and a washer and wherein the annular member is adapted to contact the at least two shell-shaped threaded-nut segments. The floor of the housing and the annular member may each include an opening configured to at least one of receive the retaining bolt and guide the retaining bolt.

The housing may comprise one of an edge which projects outwardly, a plurality of edge-segments which project outwardly and a circumferential flange which projects outwardly. The housing may comprise a circumferential flange which projects outwardly and which is adapted to be attached to the second component.

The arrangement may further comprise a vibration-damping member, wherein the connector device is arranged within the vibration damping member. The arrangement may further comprise a vibration-damping ring, wherein the connector device is surrounded by the vibration damping ring. The arrangement may further comprise a vibration-damping member comprising one of rubber and an elastomer, wherein the connector device is mounted to the vibration damping member. The arrangement may further comprise a vibration-damping ring and a hollow cylinder member, wherein the connector device is surrounded by the vibration damping ring and wherein the vibration-damping ring is connected to an inner surface of the hollow cylinder member. The hollow cylinder member may comprise one of a supporting edge which projects outwardly, a plurality of edge-segments which project outwardly, and a circumferential flange which projects outwardly. The vibration damping ring may be adapted to be mounted to an opening of the second component. The hollow cylinder member may be adapted to be mounted to an opening of the second component.

The arrangement may further comprise one of a vibration-damping material and an anti-slip material arranged on a outwardly projecting surface of the housing. The arrangement may further comprise one of a vibration-damping coating and an anti-slip coating arranged on an outwardly projecting surface of the housing. The arrangement may further comprise a follow cylinder member surrounding the housing, wherein the housing comprises an outwardly projecting surface whose outer width or diameter is greater than an inner width or diameter of the hollow cylinder member. The arrangement may further comprise a centering ring arranged at one end of the housing.

The centering ring may comprise a beveled inner edge located adjacent the opening of the housing.

The arrangement may further comprise a guide sleeve adapted to receive the retaining bolt, wherein the guide sleeve is adapted to be mounted in an opening of the first component. The guide sleeve may comprise one of a retaining edge and a retaining flange adapted to rest against the first component. The guide sleeve may comprise resilient sleeve arms whose free ends include one of tappets and projecting portions which can hook over an edge of the opening of the first component.

The invention also provides for a connector device adapted to receive a retaining bolt, wherein the member comprises a housing which includes an opening adapted to receive an end of the retaining bolt and an internal taper which tapers towards the opening. At least two shell-shaped threaded-nut segments are arranged in the housing. Each of the at least two shell-shaped threaded-nut segments comprises internal threads and an outer tapered surface which movably engages the inner tapered surface of the housing. A mechanism for biasing the at least two shell-shaped threaded-nut segments towards the opening of the housing. A vibration-damping ring surrounding the housing is provided. The at least two shell-shaped threaded-nut segments may be adapted to threadably engage the external threads of the rotatable retaining bolt.

The internal threads of each of the at least two shell-shaped threaded-nut segments may comprise partial thread sections. The housing may comprise a circumferential flange which projects outwardly and which is adapted to be attached to a component. The connector device may further comprise a vibration-damping member, wherein the connector device is arranged within the vibration damping member. The connector device may further comprise a vibration-damping ring and a hollow cylinder member, wherein the connector device is surrounded by the vibration damping ring and wherein the vibration-damping ring is connected to an inner surface of the hollow cylinder member. The hollow cylinder member may comprise one of a supporting edge which projects outwardly, a plurality of edge-segments which project outwardly, and a circumferential flange which projects outwardly.

The connector device may further comprise one of a vibration-damping material and an anti-slip material arranged on a outwardly projecting surface of the housing. The connector device may further comprise one of a vibration-damping coating and an anti-slip coating arranged on an outwardly projecting surface of the housing.

The connector device may further comprise a centering ring arranged at one end of the housing. The at least two shell-shaped threaded-nut segments may be spaced apart from each other. The connector device may further comprise stops arranged in the housing, wherein the at least two shell-shaped threaded-nut segments are spaced apart from each other via the stops. The stops may be located on an inner surface of the housing and project into spaces separating the at least two shell-shaped threaded-nut segments, whereby the stops prevent rotational movement of the at least two shell-shaped threaded-nut segments.

The mechanism for biasing may be located in the housing. The mechanism for biasing may be located between a floor of the housing and an annular member which is adapted to move axially. The annular member may comprise one of a disk and a washer and wherein the annular member is adapted to contact the at least two shell-shaped threaded-nut segments.

The invention also provides for a method of connecting the first component to the second component using the connection arrangement described above, wherein the method comprises mounting the connector device in a second opening of the second component, guiding the retaining bolt through a first opening in the first component, forcing the external threads the retaining bolt past the internal threads of the at least two shell-shaped threaded-nut segments without causing rotation of the at least two shell-shaped threaded-nut segments, allowing the at least two shell-shaped threaded-nut segments against the biasing force of the mechanism for biasing, whereby the at least two shell-shaped threaded-nut segments move away from the opening of the housing, and causing the external threads to threadably engage the internal threads of the at least two shell-shaped threaded-nut segments.

The method may further comprise rotating the retaining bolt in one direction to cause the first and second components to move towards each other. The method may further comprise rotating the retaining bolt in another direction to allow the first and second components to move away from each other. The method may further comprise, after the guiding, further guiding the retaining bolt through the opening of the housing.

The invention also provides for a connection system for detachably connecting a first component to a second component, wherein the system comprises a fastener comprising a head end, a free end, and an external thread. A connector device is adapted to receive the free end of the fastener. The connector device comprises at least two nut segments and a housing which includes an opening adapted to receive the free end and an inner tapered surface which tapers towards the opening. Each of the at least two nut segments is arranged in the housing and comprises an outer tapered surface which movably engages the inner tapered surface of the housing. A mechanism for biasing the at least two nut segments towards the opening of the housing is utilized. A vibration-damping ring surrounds the housing. The at least two shell-shaped threaded-nut segments are spaced apart from each other. The at least two nut segments are adapted to threadably engage the external threads of the fastener. The connecting arrangement is adapted to detachably connect the first component having a first opening to the second component having a second opening when the first and second openings are aligned with one another.

The invention also provides for a connection arrangement for detachably connecting a first component to a second component, wherein the arrangement comprises a retaining bolt adapted to extend through the first component. The retaining bolt comprises an external thread. A connector device is adapted to receive the retaining bolt. The connector device comprises at least two shell-shaped threaded-nut segments and a housing which includes an opening adapted to receive an end of the retaining bolt and an internal taper which tapers towards the opening. Each of the at least two shell-shaped threaded-nut segments are arranged in the housing and comprises an outer tapered surface which movably engages the internal taper of the housing. A mechanism for biasing the at least two shell-shaped threaded-nut segments towards the opening of the housing. A vibration-damping member is provided. The connector device is mounted to the vibration damping member and the at least two shell-shaped threaded-nut segments are adapted to threadably engage the external threads of the retaining bolt.

### BRIEF DESCRIPTION OF THE DRAWINGS

The present invention is further described in the detailed description which follows, in reference to the noted plurality of drawings by way of non-limiting exemplary embodiments of the present invention, in which like reference numerals represent similar parts throughout the several views of the drawings, and wherein:

FIG. 1 shows a sectional view of the detachable locking/bolting connection arrangement for connecting two components according to the invention;

FIG. 2 shows a perspective view of another embodiment of a locking/bolting connector adapted to be connected to a threaded bolt according to the invention. The connector utilizes a hollow-cylinder-type housing with two threaded nut segments; and

FIG. 3 shows a horizontal cross-section (viewed from below) of the locking/bolting connector according to FIG. 2.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

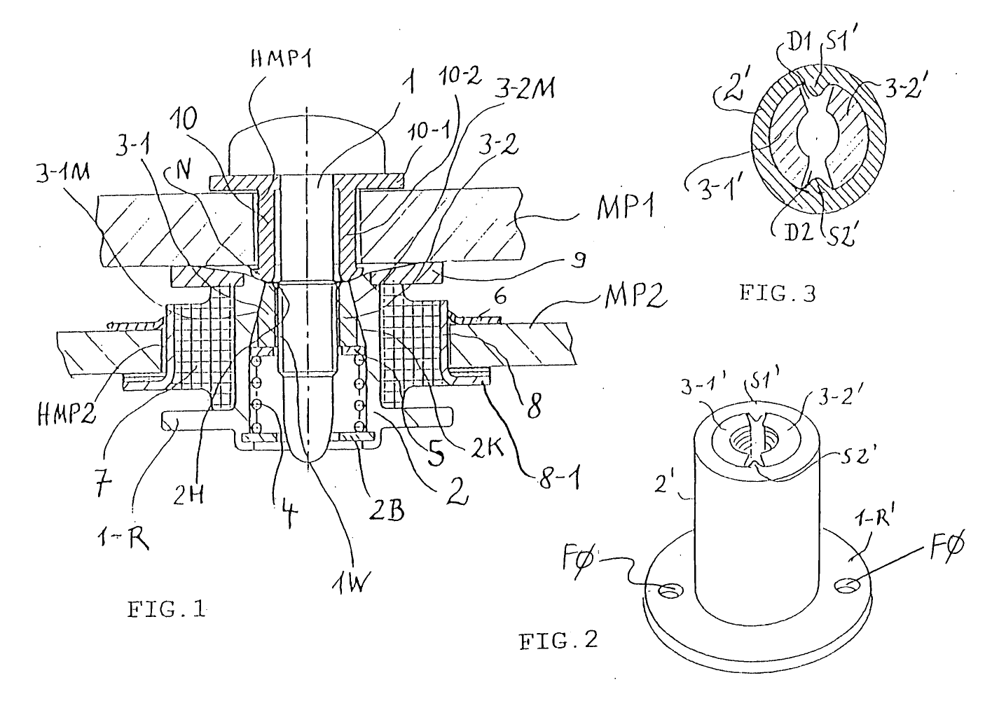

FIG. 1 shows a sectional view of the detachable locking/bolting connection arrangement. The arrangement is shown connecting two components MP1 and MP2. The first component MP1 has a first opening HMP1 and the second component has a second opening HMP2. These openings HMP1 and HMP2 are aligned with one another.

The arrangement uses a rotatable retaining bolt 1 which is located on the upper side of the first component MP1. The bolt 1 can be introduced into the various openings formed in the components MP1 and MP2 and in the bolt connector. The bolt connector is attached to the second component MP2. In the embodiment shown in FIG. 1, the bolt connector includes elements 2, 3-1, 3-2, and elements 4, 5, 6, 7, 8 and 9.

The rotatable retaining bolt 1 has an exterior or external thread 1W. The bolt connector includes a cylindrical housing 2 which includes an inner taper 2K. The inner taper 2K tapers from an inner cylindrical surface (i.e., cylindrical surface surrounding the spring 4) towards a housing opening 2H. This opening 2H is sized and configured to receive the end of the rotatable retaining bolt 1. At least two shell-shaped threaded-nut segments 3-1, 3-2 are located in the housing 2. Each of these segments 3-1 and 3-2 have an outer mantle or surface 3-1M, 3-2M which is tapered, i.e., the segments have an external bevel. The taper of the segments 3-1M and 3-2M are sized and configured to fit and/or slidably engage the interior taper 2K.

The threaded-nut segments 3-1, 3-2, and their outer surfaces 3-1M, 3-2M, move within the interior taper 2K towards and away from the housing opening 2H. Moreover, such axial movement causes the segments 3-1 and 3-2 to correspondingly move towards and away from each other.

The threaded-nut segments 3-1, 3-2 are pressed or biased towards the housing opening 2H by a spiral pressure spring 4. As a result, the rotatable retaining bolt 1 can be pressed or forced between the movable threaded-nut segments 3-1, 3-2 against the force of the spring 4 in such a way that its external threads 1W locks into the internal threads of the threaded-nut segments 3-1, 3-2. The more forcefully the bolt 1 is pressed between the threaded-nut segments 3-1, 3-2, the more thread-turns of the segments 3-1 and 3-2 lock into the threads 1W of the bolt 1 and vice versa.

In the lock and/or threaded engagement position, the threads 1W of the rotatable retaining bolt 1 are connected with the threads of the threaded-nut segments 3-1, 3-2. Moreover, by rotating the bolt 1 in one direction, the connection can be made tighter. On the other hand, threading the bolt 1 in an opposite direction, causes the connection to become un-tightened. In this way, the initial “loose” locked connection can be transformed into a secure threaded connection. Additionally, a “locked” or tightened connection can be separated by simply rotating the bolt 1 in an un-tightening direction, i.e., the connection can be detached by unscrewing the bolt 1.

The spiral spring 4 is located and/or arranged between the floor and/or annular surface 2B of the housing 2 and a disk or washer 5. The washer 5 can move in the direction of the axis of the rotatable retaining bolt 1 and lies against an annular surface of the threaded-nut segments 3-1, 3-2.

The floor 2B of the housing 2 and the disk or washer 5 each have an opening which is sized and configured to receive and/or guide the rotatable retaining bolt 1 therethrough.

The housing 2 also includes a circumferential projecting portion or edge 1-R which projects outwardly from the cylindrical housing 2. This edge 1-R may have the form of a flange which includes openings (See e.g., ref. No. 1-R′ FIG. 2) or may be in the form of projecting edge-segments which projecting outwards (not shown).

The bolt connector is located and/or mounted in a vibration-damping ring 7. The ring 7 can be made of a vibration-damping material. This material is preferably rubber or an elastomer.

An outer surface or mantle of the vibration-damping ring 7 is connected, e.g., fixedly connected, with the interior surface of an open hollow cylinder 8. This cylinder 8 has a supporting flange or edge 8-1 which extends outwardly. Alternatively, the edge 8-1 may be in the form of outwardly projecting segments.

The vibration-damping ring 7 and the hollow cylinder 8 can be securely mounted, e.g., fixedly mounted, in the opening HMP2 of the second component MP2.

In this way, an outer surface of the second component MP2 can contact or lie against the supporting edge 8-1 of the hollow cylinder 8. The edge 8-1 can also be connected to this outer surface in any desired way, e.g., by using an adhesive between the contact surfaces.

A vibration-damping and/or anti-slip material, which can be in the form of, e.g., a coating, may also be located on an inner surface of the supporting edge 8-1. This material would be sandwiched between the edge 8-1 and the outer surface of the second component MP2.

A securing ring 6 can be arranged on an inner or upper side of the second component MP2. This ring 6 ensures that the hollow cylinder 8 is secured to the second component MP2 and is arranged near an edge of hole HMP2. Th ring 6 has inwardly pointing spring-loaded tappets which are connected by spring actuation to the hollow cylinder 8, i.e., the tappets frictionally engage an outer circumferential surface of the cylinder 8. Of course, the invention contemplates that other devices can be utilized to securely connect or fix the hollow cylinder 8 to the second component MP2.

A centering ring 9 is also arranged on the bolt connector. The ring 9 includes a beveled and/or tapered inner edge which is located above the opening 2H. The ring 9 can also be secured to an upper portion of the housing 2. The purpose of the ring 9 is to help align the bolt 1 relative to the axis of the bolt connector.

The projecting edge 1-R (or the edge segments) extend beyond an internal dimension of the hollow cylinder 8, i.e., the edge 1-R has an outer diameter which is greater than an internal diameter of the cylinder 8. In this way, the lower part, i.e., edge 8-1, of the hollow cylinder 8 acts as a stop for the edge 1-R when the vibration-damping ring 7 is subject to sufficient axial deformation, i.e., deformation sufficient to allow edge 1-R to contact edge 8-1.

A guide sleeve 10 is used to mount the bolt 1 in the opening HMP1 of the first component MP1. The rotatable retaining bolt 1 is capable of rotating within an opening and the cylindrical wall 10-2 of the guide sleeve 10.

The guide sleeve 10 has a retaining flange or edge 10-1, which can also be in the form of projecting segments. The flange 10-1 has an inner annular surface which can rest or lie against an outer surface of the first component MP1. Tappets or projecting portions are arranged at an opposite end of the sleeve 10. These projections N are sized and configured to hook over the lower edge of the opening HMP1 of the component MP1.

The locking/bolting connection arrangement shown in FIG. 1 can also be designed without using a vibration-damping ring 7. In this case, the opening HMP2 would be sized to snugly receive the outer cylindrical surface of the housing 2 and the ring 6 would be sized to frictionally engage this outer cylindrical surface.

FIG. 2 shows a perspective view of another embodiment of a locking/bolting connector. As with the embodiment of FIG. 1, the bolt connector can receive and/or connect with a threaded bolt. The bolt connecter includes a housing 2′, which is in form of a hollow cylinder, and two internally threaded-nut segments 3-1′ and 3-2′.

The housing 2′ has a flange or edge 1-R′ which projects outwardly. The flange 1-R′ can also openings FO. As with the embodiment of FIG. 1, this flange 1-R′ can alternatively have the form of outwardly projecting edge segments.

The outwardly projecting edge 1-R′ is configured to act as an assembly flange 1-R′ and can facilitate attachment to a component, e.g., second component MP2. In this regard, fasteners can be used to fasten the flange 1-R′ to the component using the openings FO. Of course, the flange 1-R′ can also be attached using an adhesive, as was described with regard to FIG. 1. Moreover, the flange 1-R′ can also include the anti-slip or vibration dampening material as in the embodiment shown in FIG. 1.

As with the embodiment shown in FIG. 1, two threaded-nut segments 3-1′ and 3-2′ are located the interior of the housing 2′. Moreover, as with the embodiment shown in FIG. 1, the bolt connector shown in FIG. 2 can include the spring 4, tapers 3-1M, 3-2M, 2K, floor 2B and washer 5. For reasons of simplification, however, the interior taper and the spiral pressure spring etc. are not shown in FIG. 2.

FIG. 3 shows a horizontal sectional view of the locking/bolting connector according to FIG. 2 (looking upwards). The designations for the housing, the two threaded-nut segments, the spaces and the stops are the same as in FIG. 2.

The threaded-nut segments 3-1′, 3-2′ have a space between them, i.e., they are spaced apart. Oppositely arranged stops S1′ and S2′ project from the interior wall of housing 2′ into the spaces D1, D2 which are defined between the threaded-nut segments 3-1′, 3-2′. These stops S1′ and S2′ are sized and configured to limit the axial rotatability of the threaded-nut segments 3-1′, 3-2′.

The retaining bolt 1 and bolt connector can be of the type that is known in the art. Document EP 03 52 542, the disclosure of which is expressly incorporated by reference in its entirety, illustrates such devices. Moreover, the invention provides an arrangement in which the more forcefully the bolt 1 is pressed into and/or between the threaded-nut segments 3-1, 3-2, the more thread-turns of the segments lock into the threads of the bolt 1. Thereafter, rotating the bolt 1 in the tightening direction causes further tightening of the bolt 1 into the threads of the segments. Rotating the bolt 1 in the opposite direction causes a loosening of the bolt threads within the threaded-nut segments 3-1, 3-2.

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed:

1. A connection arrangement for detachably connecting a first component to a second component, the arrangement comprising:
a retaining bolt adapted to extend through the first component;
the retaining bolt comprising an external thread;
a connector device being adapted to receive the retaining bolt;
the connector device comprising at least two shell-shaped threaded-nut segments and a housing which includes an opening adapted to receive an end of the retaining bolt and an internal taper which tapers towards the opening;
each of the at least two shell-shaped threaded-nut segments being arranged in the housing and comprising an outer tapered surface which movably engages the internal taper of the housing;
a mechanism for biasing the at least two shell-shaped threaded-nut segments towards the opening of the housing; and
a vibration-damping member,
wherein the connector device is mounted to the vibration damping member, and
wherein the at least two shell-shaped threaded-nut segments are adapted to threadably engage the external threads of the retaining bolt.

2. The arrangement of claim 1, wherein the connecting arrangement is adapted to detachably connect the first component having a first opening to the second component having a second opening when the first and second openings are aligned with one another.

3. The arrangement of claim 1, wherein the outer tapered surface of each shell-shaped threaded-nut segment has the form of a bevel.

4. The arrangement of claim 1, wherein each of the at least two shell-shaped threaded-nut segments are adapted to move towards and away from the opening of the housing.

5. The arrangement of claim 1, wherein the mechanism for biasing the at least two shell-shaped threaded-nut segments towards the opening of the housing comprises a spring.

6. The arrangement of claim 1, wherein the retaining bolt is adapted to move the at least two shell-shaped threaded-nut segments against the biasing force of the mechanism for biasing, wherein the external threads of the retaining bolt are adapted to move, without rotating, past internal threads of the at least two shell-shaped threaded-nut segments, and wherein the external thread of the retaining bolt are adapted to threadably engage with the internal threads of the at least two shell-shaped threaded-nut segments when the retaining bolt is rotated.

7. The arrangement of claim 1, wherein the at least two shell-shaped threaded-nut segments are spaced apart from each other.

8. The arrangement of claim 1, further comprising stops arranged in the housing, wherein the at least two shell-shaped threaded-nut segments are spaced apart from each other via the stops.

9. The arrangement of claim 8, wherein the stops are located on an inner surface of the housing and project into spaces separating the at least two shell-shaped threaded-nut segments, whereby the stops prevent rotational movement of the at least two shell-shaped threaded-nut segments.

10. The arrangement of claim 1, wherein the mechanism for biasing is located in the housing.

11. The arrangement of claim 1, wherein the mechanism for biasing is located between a floor of the housing and an annular member which is adapted to move axially.

12. The arrangement of claim 11, wherein the annular member comprises one of a disk and a washer and wherein the annular member is adapted to contact the at least two shell-shaped threaded-nut segments.

13. The arrangement of claim 11, wherein the floor of the housing and the annular member each include an opening configured to at least one of receive the retaining bolt and guide the retaining bolt.

14. The arrangement of claim 1, wherein the housing comprises one of an edge which projects outwardly, a plurality of edge-segments which project outwardly and a circumferential flange which projects outwardly.

15. The arrangement of claim 1, wherein the housing comprises a circumferential flange which projects outwardly and which is adapted to be attached to the second component.

16. The arrangement of claim 1, wherein the connector device is arranged within the vibration damping member.

17. The arrangement of claim 1, wherein the vibration-damping member is a vibration-damping ring and wherein the connector device is surrounded by the vibration damping ring.

18. The arrangement of claim 1, wherein the vibration-damping member comprises one of rubber and an elastomer.

19. The arrangement of claim 1, wherein the vibration-damping member comprises a vibration damping ring and a hollow cylinder member, wherein the connector device is surrounded by the vibration damping ring, and wherein the vibration-damping ring is connected to an inner surface of the hollow cylinder member.

20. The arrangement of claim 19, wherein the hollow cylinder member comprises one of a supporting edge which projects outwardly, a plurality of edge-segments which project outwardly, and a circumferential flange which projects outwardly.

21. The arrangement of claim 20, wherein the vibration damping ring is adapted to be mounted to an opening of the second component.

22. The arrangement of claim 20, wherein the hollow cylinder member is adapted to be mounted to an opening of the second component.

23. The arrangement of claim 1, further comprising one of a vibration-damping material and an anti-slip material arranged on a outwardly projecting surface of the housing.

24. The arrangement of claim 1, further comprising one of a vibration-damping coating and an anti-slip coating arranged on an outwardly projecting surface of the housing.

25. The arrangement of claim 1, further comprising a hollow cylinder member surrounding the housing, wherein the housing comprises an outwardly projecting surface whose outer width or diameter is greater than an inner width or diameter of the hollow cylinder member.

26. The arrangement of claim 1, further comprising a centering ring arranged at one end of the housing.

27. The arrangement of claim 1, wherein the centering ring comprises a beveled inner edge located adjacent the opening of the housing.

28. The arrangement of claim 1, further comprising a guide sleeve adapted to receive the retaining bolt, wherein the guide sleeve is adapted to be mounted in an opening of the first component.

29. The arrangement of claim 28, wherein the guide sleeve comprises one of a retaining edge and a retaining flange adapted to rest against the first component.

30. The arrangement of claim 29, wherein the guide sleeve comprises resilient sleeve arms whose free ends include one of tappets and projecting portions which can hook over an edge of the opening of the first component.

31. A connector device adapted to receive a retaining bolt, the member comprising:
a housing which includes an opening adapted to receive an end of the retaining bolt and an internal taper which tapers towards the opening;
at least two shell-shaped threaded-nut segments arranged in the housing;
each of the at least two shell-shaped threaded-nut segments comprising internal threads and an outer tapered surface which movably engages the internal taper of the housing; and
a mechanism for biasing the at least two shell-shaped threaded-nut segments towards the opening of the housing; and
a vibration-damping ring surrounding the housing,
wherein the at least two shell-shaped threaded-nut segments are adapted to threadably engage the external threads of the rotatable retaining bolt.

32. The connector device of claim 31, wherein the internal threads of each of the at least two shell-shaped threaded-nut segments comprises partial thread sections.

33. The connector device of claim 31, wherein the housing comprises a circumferential flange which projects outwardly and which is adapted to be attached to a component.

34. The connector device of claim 31, wherein the housing is arranged within the vibration damping ring.

35. The connector device of claim 31, further comprising a hollow cylinder member, wherein the housing is surrounded by the vibration damping ring and wherein the vibration-damping ring is connected to an inner surface of the hollow cylinder member.

36. The connector device of claim 35, wherein the hollow cylinder member comprises one of a supporting edge which projects outwardly, a plurality of edge-segments which project outwardly, and a circumferential flange which projects outwardly.

37. The connector device of claim 31, further comprising one of a vibration-damping material and an anti-slip material arranged on a outwardly projecting surface of the housing.

38. The connector device of claim 31, further comprising one of a vibration-damping coating and an anti-slip coating arranged on an outwardly projecting surface of the housing.

39. The connector device of claim 31, further comprising a centering ring arranged at one end of the housing.

40. The connector device of claim 31, wherein the at least two shell-shaped threaded-nut segments are spaced apart from each other.

41. The connector device of claim 31, further comprising stops arranged in the housing,
wherein the at least two shell-shaped threaded-nut segments are spaced apart from each other via the stops.

42. The connector device of claim 41, wherein the stops are located on an inner surface of the housing and project into spaces separating the at least two shell-shaped threaded-nut segments, whereby the stops prevent rotational movement of the at least two shell-shaped threaded-nut segments.

43. The connector device of claim 31, wherein the mechanism for biasing is located in the housing.

44. The connector device of claim 31, wherein the mechanism for biasing is located between a floor of the housing and an annular member which is adapted to move axially.

45. The connector device of claim 44, wherein the annular member comprises one of a disk and a washer and wherein the annular member is adapted to contact the at least two shell-shaped threaded-nut segments.

46. A method of connecting the first component to the second component using the connection arrangement of claim 1, the method comprising:
mounting the connector device in a second opening of the second component;
guiding the retaining bolt through a first opening in the first component;
forcing the external threads the retaining bolt past the internal threads of the at least two shell-shaped threaded-nut segments without causing rotation of the at least two shell-shaped threaded-nut segments;
allowing the at least two shell-shaped threaded-nut segments against the biasing force of the mechanism for biasing, whereby the at least two shell-shaped threaded-nut segments move away from the opening of the housing; and
threadably engaging the external threads of the retaining bolt and the internal threads of the at least two shell-shaped threaded-nut segments.

47. The method of claim 46, further comprising rotating the retaining bolt in one direction to cause the first and second components to move towards each other.

48. The method of claim 47, further comprising rotating the retaining bolt in another direction to allow the first and second components to move away from each other.

49. The method of claim 46, further comprising, after the guiding, further guiding the retaining bolt through the opening of the housing.

50. A connection system for detachably connecting a first component to a second component, the system comprising:
a fastener comprising a head end, a free end, and an external thread;
a connector device adapted to receive the free end of the fastener;
the connector device comprising at least two nut segments and a housing which includes an outwardly projecting flange, an opening adapted to receive the free end, and an internal taper which tapers towards the opening;
each of the at least two nut segments being arranged in the housing and comprising an outer tapered surface which movably engages the inner tapered surface of the housing;
a mechanism for biasing the at least two nut segments towards the opening of the housing;
a vibration-damping ring surrounding the housing,
wherein the at least two shell-shaped threaded-nut segments are spaced apart from each other,
wherein the at least two nut segments are adapted to threadably engage the external threads of the fastener, and
wherein the connecting arrangement is adapted to detachably connect the first component having a first opening to the second component having a second opening when the first and second openings are aligned with one another.
